(19) United States
(12) Patent Application Publication
(10) Pub. No.: US 2025/0154843 A1
(43) Pub. Date: May 15, 2025

(54) Jam release device, system, model and design method for coiled tube drilling rigs

(71) Applicant: Beijing Goaldrill Technology Co., Ltd., Beijing (CN)

(72) Inventors: Jiaqi CHEN, Beijing (CN); Yanfeng SHI, Beijing (CN); Xiaoming CAO, Beijing (CN)

(21) Appl. No.: 18/623,688

(22) Filed: Apr. 1, 2024

(30) Foreign Application Priority Data
Nov. 9, 2023 (CN) 2023114855409

(51) Int. Cl. E21B 31/00

(52) U.S. Cl. CPC E21B 31/005

(57) ABSTRACT

The present invention is applicable to the technical field of drilling equipment and provides a jam release device for coiled tube drilling rigs, a jam release system for coiled tube drilling rigs, a jam release device model for coiled tube drilling rigs, and a jam release device model design method for coiled tube drilling rigs. The jam release device for coiled tube drilling rigs comprises: a drive shaft, a first lever and a second lever, wherein the second lever is rotationally connected to a base frame via a second fulcrum, and on the second lever are further provided a second groove and an output groove; on the first lever is further fixedly provided a transmission end, which is slidably connected to the second groove, so as to drive the second lever to rotate around the second fulcrum; and an output end portion is slidably arranged on the output groove.

### TECHNICAL FIELD

The present invention belongs to the technical field of drilling equipment, particularly relating to a jam release device for coiled tube drilling rigs, a jam release system for coiled tube drilling rigs, a jam release device model for coiled tube drilling rigs, and a jam release device design method for coiled tubing drilling rigs.

### BACKGROUND TECHNOLOGY

Coiled tube drilling rigs are a type of drilling equipment used for soil or underground rock strata, which advance drill rods and simultaneously retrieve cuttings by rotating the drill rods and bits, so as to achieve continuous drilling operations. Compared to traditional drilling methods, coiled tube drilling rigs are characterized in high efficiency, stability, and safety, and mainly comprise drill rods, drill bits, drive systems, and mud circulation systems, wherein each one of the drill rods comprises one or several pipe sections, each of which comprises a connector, allowing the drill rods to continuously extend during drilling; through the drive systems, the drill rods and bits are rotated and advanced underground, while the mud circulation systems pump mud into the drill rods and carry away cuttings.

During a coiled tube drilling process, drill stuck problems are prone to occurring due to rock formation hole collapse, mudstone necking, drill cuttings deposition and other conditions. However, since coiled tube drilling rigs cannot drive drill strings to rotate axially, it is difficult for this type of rigs to realize salvage methods such as continuous torsion tripping and powerful salvage using traditional rotary directional drilling rigs.

Therefore, it is evident that existing coiled tube drilling rigs are prone to getting stuck during operation, and it is difficult to effectively and quickly release the stuck, which significantly impacts the operation efficiency and reliability of the coiled tube drilling rigs.

### SUMMARY OF THE INVENTION

One object of embodiments of the present invention is to provide a jam release device for coiled tube drilling rigs, so as to address issues related to the susceptibility of existing coiled tube drilling rigs to getting stuck during operation and the difficulty in effectively and rapidly removing the stuck after drills are stuck, resulting low operational efficiency and low reliability of coiled tube drilling rigs.

The embodiments of the present invention are implemented through following technical solutions: provided is a jam release device for coiled tube drilling rigs, comprising:
a drive shaft, wherein an end portion of the drive shaft is fixed on a motor rotating shaft of a drive motor, the drive motor is fixedly connected to a base frame, so as to drive the drive shaft to rotate centered on a connection point thereof with the drive motor; a first lever, wherein the first lever is rotationally connected to the base frame via a first fulcrum, on the first lever is further provided a first groove, on the drive shaft is fixedly provided an input end portion, the input end portion is slidably connected to the first groove, so as to drive the first lever to rotate around the first fulcrum; and a second lever, wherein the second lever is rotationally connected to the base frame via a second fulcrum, and on the second lever are further provided a second groove and an output groove; on the first lever is further fixedly provided a transmission end, the transmission end is slidably connected to the second groove, so as to drive the second lever to rotate around the second fulcrum, on the output groove is slidably arranged an output end portion, and the output end portion is used to connect with a base of a chain roller system of a drilling rig, so that the chain roller system applies high-frequency axial vibration excitation to coiled tubes clamped.

A second object of embodiments of the present invention is to provide a jam release system for coiled tube drilling rigs, wherein the jam release system for coiled tube drilling rigs comprises at least two jam release devices as mentioned above; when the jam release system comprises two jam release devices for coiled tube drilling rigs, referred to as a first jam release device for coiled tube drilling rigs and a second jam release device for coiled tube drilling rigs; output end portions of both the first and second jam release devices for coiled tube drilling rigs are symmetrically arranged on two sides of a base of a chain roller system of a drilling rig.

Another object of embodiments is to provide a jam release model for coiled tube drilling rigs, comprising: a drive shaft assembly, wherein an end portion of the drive shaft assembly is fixed to a motor rotating shaft of a drive motor assembly, the drive motor assembly is fixedly connected to a base frame assembly so as to drive the drive shaft assembly to rotate around a connection point thereof with the drive motor assembly; a first lever assembly, wherein the first lever assembly is rationally connected to the base frame assembly via a first fulcrum, the first lever assembly is further provided with a first groove, on the drive shaft assembly is further fixedly provided an input end portion, and the input end portion is slidably connected to the first groove on the first lever assembly so as to drive the first lever assembly to rotate around the first fulcrum; a second lever assembly, wherein the second lever assembly is rotationally connected to the base frame assembly via a second fulcrum, the second lever assembly is further provided with a second groove and an output groove, on the first lever assembly is fixedly provided a transmission end, and the transmission end is slidably connected to the second groove on the second lever assembly, so as to drive the second lever assembly to rotate around the second fulcrum; and on the output groove is slidably arranged an output end portion, the output end portion is used to connect with a chain roller base system model of a drilling rig, so that the chain roller system model applies high-frequency axial vibration excitation to a coiled tube clamped.

A third object of embodiments of the present invention is to provide a design method of a jam release device for coiled tube drilling rigs, comprising following steps: modeling the jam release device for coiled tube drilling rigs as mentioned above to obtain a jam release device model for coiled tube drilling rigs; performing dynamics modeling of components in the jam release device model for coiled tube drilling rigs to obtain dynamic equations of the components; accumulating kinetic energies and potential energies in the dynamic equations of the components to obtain a total kinetic energy and a total potential energy of a system; calculating generalized forces corresponding to generalized coordinates caused by active forces on the jam release device model for coiled tube drilling rigs and all contacts of the components; utilizing Lagrange multipliers and gradients of constraints on the generalized coordinates to obtain generalized forces contributed by constraints, thus obtaining a first Lagrange equation set for the jam device model for coiled tube drilling rigs; transforming the first Lagrange equation set into a general form to obtain a time-varying nonlinear differential-algebraic equation set for the jam release device model for coiled tube drilling rigs; and solving the time-varying nonlinear differential-algebraic equation set for the jam release device model for coiled tube drilling rigs to obtain transient time responses during large-scale motion processes, thereby getting motion trajectories and flexible body deformation status information of the components within the jam release device model for coiled tube drilling rigs.

The jam release device for coiled tube drilling rigs provided in the embodiments of the present invention significantly amplifies thrust forces at the input end portion, thereby driving coiled tubes to implement axial high-frequency vibration under large thrust, efficiently achieving jam release when encountering stuck drill problems, and effectively overcoming the problem of weight-on-bit loss caused by static friction between coiled tubes and hole walls.

### BRIEF DESCRIPTION OF THE DRAWINGS

FIG. 1 is a schematic diagram of a jam release device for coiled tube drilling rigs provided in an embodiment of the present invention.

FIG. 2 is a schematic diagram of a jam release system for coiled tube drilling rigs provided in an embodiment of the present invention.

FIG. 3 is a schematic diagram of a rigid body provided in an embodiment of the present invention.

FIG. 4 is a schematic diagram of a beam element provided in an embodiment of the present invention.

FIG. 5 is a flow chart of numerical integration for solving differential algebraic equations provided in an embodiment of the present invention.

FIG. 6 shows maximum shear stress distribution of a two-lever section provided in an embodiment of the present invention.

FIG. 7 is a diagram recording an iterative process provided in an embodiment of the present invention.

FIG. 8 shows load and deformation conditions during first lever operation in an embodiment of the present invention.

FIG. 9 shows load and deformation conditions during second lever operation in an embodiment of the present invention.

FIG. 10 is a schematic diagram of a digital model of a jam release system for coiled tube drilling rigs provided in an embodiment of the present invention.

FIG. 11 is a schematic diagram of a second digital model of the jam release system provided in an embodiment of the present invention.

FIG. 12 is a schematic diagram of a third digital model of a jam release system provided in an embodiment of the present invention.

FIG. 13 shows time-domain variation curves of left and right double lever driving torques, injector head thrust, and drill bit constraint forces in an embodiment of the present invention.

FIG. 14 shows loading and deformation conditions during first lever operation in an embodiment of the present invention.

FIG. 15 shows loading and deformation conditions during second lever operation in an embodiment of the present invention.

FIG. 16 shows time-domain variation curves of left and right double lever driving torques, injector head thrust, and drill bit constraint forces in another embodiment of the present invention.

FIG. 17 shows loading and deformation conditions during first lever operation in another embodiment of the present invention.

FIG. 18 shows load and deformation conditions during second lever operation in an embodiment of the present invention.

FIG. 19 is a schematic diagram of a fourth digital model of a jam release system for coiled tube drilling rigs provided in an embodiment of the present invention.

The markups in the drawings are indicated as follows: 10—motor rotating shaft; 11—drive shaft; 12—input end portion; 20—first fulcrum; 21—first lever; 22—second fulcrum; 23—first groove; 30—second fulcrum; 31—second lever; 32—second groove; 33—output end portion.

### Special Embodiments

To make the purpose, technical solutions, and advantages of the present invention clearer, a further detailed description of the present invention is provided below in conjunction with the drawings and embodiments. It should be understood that specific embodiments described herein are only used to explain the present invention and are not intended to limit the present invention.

It can be understood that the terms “first,” “second,” etc., used in this application can be used to describe various components in this document, but unless otherwise specified, these components are not limited by these terms. These terms are only used to distinguish one component from another. For example, without departing from the scope of the present invention, a first script can be referred to as a second script, and similarly, the second script can be referred to as the first script.

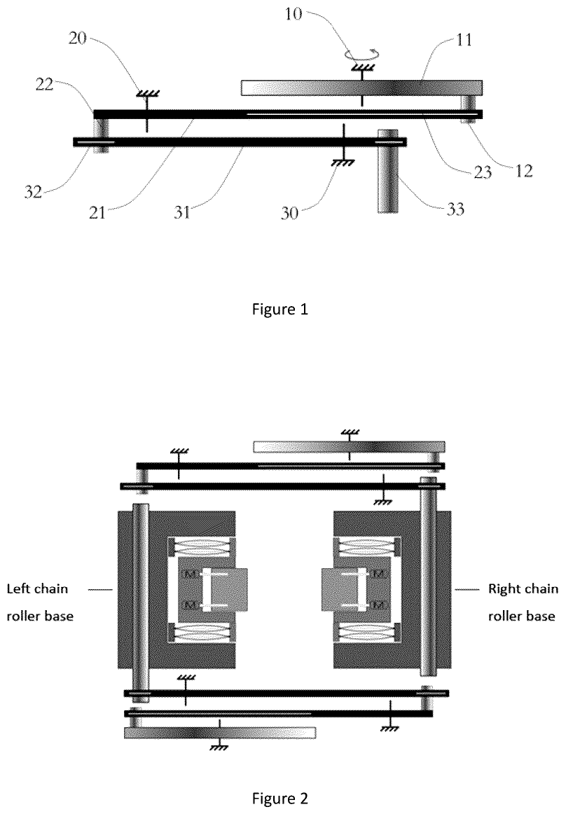

As shown in FIG. 1, an embodiment provides a jam release device for coiled tube drilling rigs, characterized in that the jam release device for coiled tube drilling rigs comprises:
a drive shaft, wherein an end portion of the drive shaft is fixed on a motor rotating shaft of a drive motor, the drive motor is fixedly connected to a base frame, so as to drive the drive shaft to rotate centered on a connection point thereof with the drive motor;
a first lever, wherein the first lever is rotationally connected to the base frame via a first fulcrum, on the first lever is further provided a first groove, on the drive shaft is fixedly provided an input end portion, the input end portion is slidably connected to the first groove, so as to drive the first lever to rotate around the first fulcrum;
a second lever, wherein the second lever is rotationally connected to the base frame via a second fulcrum, and on the second lever is further provided a second groove and an output groove; on the first lever is further fixedly provided a transmission end, the transmission end is slidably connected to the second groove, so as to drive the second lever to rotate around the second fulcrum; and
on the output groove is slidably arranged an output end portion, and the output end portion is used to connect with a base of a chain roller system of a drilling rig, so that the chain roller system applies high-frequency axial vibration excitation to coiled tubes clamped.

Those skilled in the art will understand that traditional coiled tube drilling rigs cannot drive drill strings to rotate axially, and thus it is difficult to realize salvage methods such as continuous torsion tripping and powerful salvage using traditional rotary directional drilling rigs. In order to provide a feasible means of releasing jam for coiled tube drilling rigs and solve the common jam problems in horizontal drilling in mines, the present embodiment adopts principle of lever to design a shaking and jam release mechanism, which can amplify trust at input end portions dozens of times, and drive coiled tube drilling rigs to perform axial high-frequency vibration under the action of large trust, thereby solving the problem of stuck drill and also effectively overcoming the problem of drilling weight loss caused by the static friction between coiled tubes and hole walls.

In the present embodiment, the working principle of the mechanism as illustrated in FIG. 1 comprises a drive shaft, a first lever, a second lever, an output end portion, and other structures, wherein the drive shaft is rotationally mounted on the base; a short column extending from the drive shaft connects to the first lever through a straight notch and drives the first lever to reciprocate around the first fulcrum; the first lever and the second lever are also connected through a straight notch, driving the second lever to reciprocate around the second fulcrum; finally, the second lever is connected to the output end portion through a straight notch, driving the output end portion to reciprocate in a direction perpendicular to a plane. The output end portion and the base on which the output end portion is installed through translation to ensure reciprocating motion in a fixed direction.

In the present embodiment, bases of drive discs of the device are fixedly connected to frames of injector heads, while the output end portions thereof are fixedly connected to the bases of the injector head's chain roller systems on both sides, with two-lever devices installed on upper and lower portions of both sides. When the chain roller systems clamp coiled tubes, the drive discs at both sides work synchronously and apply high-frequency axial vibration excitation to the coiled tubes to help release stuck drill strings. Simultaneously, static friction is converted into dynamic friction during regular operations to reduce wall friction.

In one embodiment, the drive shaft is disc-shaped, and the motor rotating shaft of the drive motor is connected to a center portion of the disc-shaped drive shaft, while an input end portion is located at an edge portion of the disc-shaped drive shaft.

In the present embodiment, the disc-shaped drive shaft provides greater structural strength and balance so as to drive.

In one embodiment, a distance between the input end portion and the first fulcrum is greater than a distance between the transmission end and the first fulcrum, and the distance between the transmission end and the second fulcrum is greater than the distance between the output end portion and the second fulcrum. And specific positions of the input end portion, the first fulcrum, the second fulcrum, the transmission end, and the output end portion are as shown in FIG. 1.

In the present embodiment of the present invention, torque is amplified through the above arrangement, thereby improving the vibration jam release effect.

As shown in FIG. 2, an embodiment of the present invention provides a jam release system for coiled tube drilling rigs comprising at least two jam release devices for coiled tube drilling rigs above;
when the jam release system for coiled tube drilling rigs comprises two jam release devices for coiled tube drilling rigs, marked as a first jam release device for coiled tube drilling rigs and a second jam release device for coiled tube drilling rigs; and
an output end portion of the first jam release device for coiled tube drilling rigs and an output end portion of the second jam release device for coiled tube drilling rigs are arranged on symmetrical two sides of bases of chain roller systems of a coiled tube drilling rig.

In the present embodiment of the present invention, the description of a jam release device for coiled tube drilling rigs is as described above and will not repeated here. Two relatively symmetrically arranged jam release devices for coiled tube drilling rigs make the system more stable and efficient and improve the structural reliability of the device and the jam efficiency. It is understandable that 3, 4 or more jam release devices for coiled tube drilling rigs can be arranged in a symmetrical manner to improve the structural strength and jam-releasing effect.

One embodiment of the present invention provides a jam release device model for coiled tube drilling rigs, comprising:
a drive shaft assembly, wherein an end portion of the drive shaft assembly is fixed to a motor rotating shaft of a drive motor assembly, the drive motor assembly is fixedly connected to a base frame assembly, so as to drive the drive shaft assembly to rotate around a connection point thereof with the drive motor assembly;
a first lever assembly, wherein the first lever assembly is rotationally connected to the base frame assembly via a first fulcrum, the first lever assembly is further provided with a first groove, on the drive shaft assembly is further fixedly provided an input end portion, and the input end portion is slidably connected to the first groove on the first lever assembly, so as to drive the first lever assembly to rotate around the first fulcrum;
a second lever assembly, wherein the second lever assembly is rotationally connected to the base frame assembly via a second fulcrum, the second lever assembly is further provided with a second groove and an output groove, on the first lever assembly is fixedly provided a transmission end, and the transmission end is slidably connected to the second groove on the second lever assembly, so as to drive the second lever assembly to rotate around the second fulcrum; and
on the output groove is slidably arranged an output end portion, the output end portion is used to connect with a chain roller base system model of a drilling rig, so that the chain roller system model applies high-frequency axial vibration excitation to a coiled tube clamped.

Those skilled in the art know that the above model may refer to a 3D component entity, a mathematical representation of an entity model, or a digital virtual component model.

In the present embodiment of the present invention, FIG. 1 can also represent a digital model of a jam release device for coiled tube drilling rigs, and dynamics modeling can be performed on this model, and then through simulation of the digital model, structural data parameters of the actual device can be optimized according to the actual situation, and the operating efficiency of the device can be improved.

In the present embodiment of the present invention, dynamics modeling can be performed on the above model, and a dynamic model of the double-lever jam release mechanism comprises rigid bodies and beam elements, wherein deformation of the drive discs and the output end portions is so small that they are simplified to rigid bodies for modeling; and both two levers are modeled using beam elements.

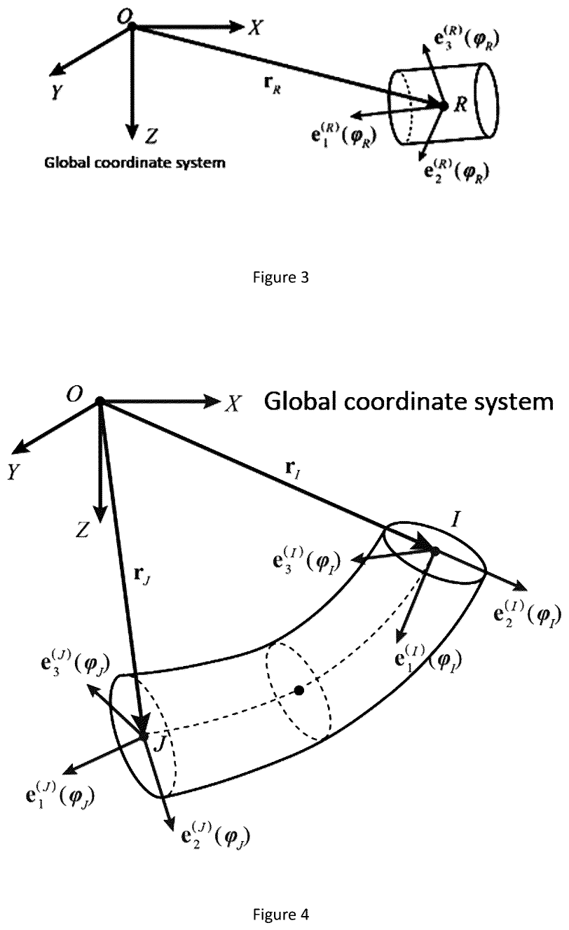

For long strip connectors at both ends of support structure systems, rigid bodies can be used for modeling, and a schematic diagram of a rigid body is shown in FIG. 3. Let a generalized coordinate be: q_{R}=[r_{R}^{T} φ_{R}^{T}]^{T}, where r_{R} represents a position of a center of mass of a rigid body, φ_{R} represents an attitude of the rigid body, generalized velocity and acceleration thereof are expressed as:

$${\dot{q}}_{R} = {[ {\dot{r}}_{R}^{T} {φ}_{R}^{T} ]}^{T} and {\ddot{q}}_{R} = {[ {\ddot{r}}_{{R}^{T}} {φ}_{R}^{T} ]}^{T} ,$$

angular velocity and angular acceleration velocity of the rigid body are expressed in a local coordinate system as:

$${\overline{ω}}_{R} = {H}^{T} {\dot{φ}}_{R} and {\dot{\overline{ω}}}_{R} = {H}^{T} {\ddot{φ}}_{R} + {\dot{H}}^{T} {\dot{φ}}_{R} ,$$

where H represents transformation matrix, for any rotation vector φ=[φ₁ φ₂ φ₃]^{T}, an equation is obtained as follows:

$$H ( φ ) = I + \frac{1 - cos φ}{{φ}^{2}} \tilde{φ} + \frac{φ - sin φ}{{φ}^{3}} \tilde{φ} \tilde{φ} ,$$

where φ=∥φ∥, and \tilde{φ} is a corresponding anti-symmetric matrix of φ, and a generalized inertial force of the rigid body is expressed as follows:

$${Q}_{iner}^{R} = [ \begin{matrix}{Q}_{t}^{R} \\ {Q}_{r}^{R}\end{matrix} ] = - [ \begin{matrix} & m {\ddot{r}}_{R} \\ H [ {J}_{R} {\dot{\overline{ω}}}_{R} & + {\overline{ω}}_{R} \times ( {J}_{R} {\overline{ω}}_{R} ) ]\end{matrix} ] ,$$

where J_{R}=diag(J_{Rx} J_{Ry} J_{Rz}) represents a principal moment of inertia tensor of the rigid body in the local coordinate system.

In summary, a rigid body dynamics equation is obtained as follows:

$${Q}_{iner}^{R} + {Q}_{ext}^{R} + {Q}_{cons}^{R} = 0 ,$$

where Qₑₓₜ^{R} and Q_{cons}^{R} cons refer to generalized external force and generalized constraint force on the rigid body.

In one embodiment, a beam element can be modeled as shown in FIG. 4, and sheets in a support structure system are modeled by using Timoshenko beam elements based on the Lagrangian method. Let generalized coordinates of the beam elements be:

$${q}_{B} = {[ {q}_{I}^{T} {q}_{J}^{T} ]}^{T} = {[ {r}_{I}^{T} {φ}_{I}^{T} {r}_{J}^{T} {φ}_{J}^{T} ]}^{T} ,$$

and generalized inertial forces of the beam elements be:

$${Q}_{iner}^{B} = - ρ AL [ {\int }_{0}^{1} {N}_{r}^{T} {N}_{r} d ξ ] {q}_{B} - ρ L {\int }_{0}^{1} \{ {N}_{φ}^{T} H [ J {\dot{\overline{ω}}}_{B} + {\overline{ω}}_{B} \times ( J {\overline{ω}}_{B} ) ] \} d ξ ,$$

where ρ [symbol] A and L represent density, cross-sectional area and length of the beam elements respectively; and Nᵣ and N_{φ} represent form functions of translational and rotational coordinates respectively; and
generalized elastic forces of the beam elements are expressed:

$${Q}_{elas}^{B} = - L {\int }_{0}^{1} [ {( \frac{\partial \overline{γ}}{\partial {q}_{B}} )}^{T} \overline{Γ} + {( \frac{\partial \overline{κ}}{\partial {q}_{B}} )}^{T} \overline{M} ] d ξ ,$$

where γ̅ and Γ̅ respectively represent strain vectors of the beam elements and corresponding internal forces thereof, κ̅ and M̅ respectively represent bending vectors of the beam elements and corresponding internal forces thereof.

In summary, dynamic equation of the beam elements is obtained as follows:

$${Q}_{iner}^{B} + {Q}_{elas}^{B} + {Q}_{ext}^{B} + {Q}_{cons}^{B} = 0 ,$$

where, Qₑₓₜ^{B} and Q_{cons}^{B} represent generalized external force and generalized constraint force on the beam element.

In one embodiment, all generalized coordinates of all components in the system are listed together to form a generalized coordinate vector of the system as follows:

$$q = {[ {q}_{1} , {q}_{2} , … , {q}_{k} ]}^{T} ,$$

then all constraints on the generalized coordinates of the system are listed as follows:

$${C}_{α} ( q , t ) = 0 , and α = 1 , … , m .$$

and kinetic energies and potential energies of all components are accumulated to obtain a total kinetic energy T and a total potential energy U of the system, and meanwhile, active forces exerted on the system and the generalized forces [symbol] corresponding to all generalized coordinates caused by all contacts are calculated, and then generalized forces contributed by the all constraints are obtained through Lagrange multipliers λ_{α} and gradients of the all constraints on the generalized coordinates

$$\frac{\partial {C}_{α}}{\partial {q}_{j}} ,$$

and finally a first kind of Lagrangian equation of the system is gotten as follows:

$$\{ \begin{matrix}\frac{d}{dt} \frac{\partial T}{\partial {\dot{q}}_{j}} - \frac{\partial T}{\partial {q}_{j}} + \frac{\partial U}{\partial {q}_{j}} + {\sum }_{α = 1}^{m} {λ}_{α} \frac{\partial {C}_{α}}{\partial {q}_{j}} - {Q}_{j}^{e} = 0 , j = 1 , … , k \\ {C}_{α} ( q , t ) = 0 , α = 1 , … , m\end{matrix}$$

dynamic equation of the system can be further expressed in following matrix form:

$$\{ \begin{matrix}M \ddot{q} + {C}_{q}^{T} λ - Q ( \dot{q} , q , t ) = 0 \\ C ( q , t ) = 0\end{matrix} ,$$

and by introducing notations y=(q^{T}, λ^{T})^{T} and λ=(λ₁, . . . , λₘ)^{T}, a more general form of the above equation is obtained:

$$F ( y , \dot{y} , \ddot{y} , t ) = 0$$

where \dot{y} and ÿ represent first and second derivatives of y with respect to time t.

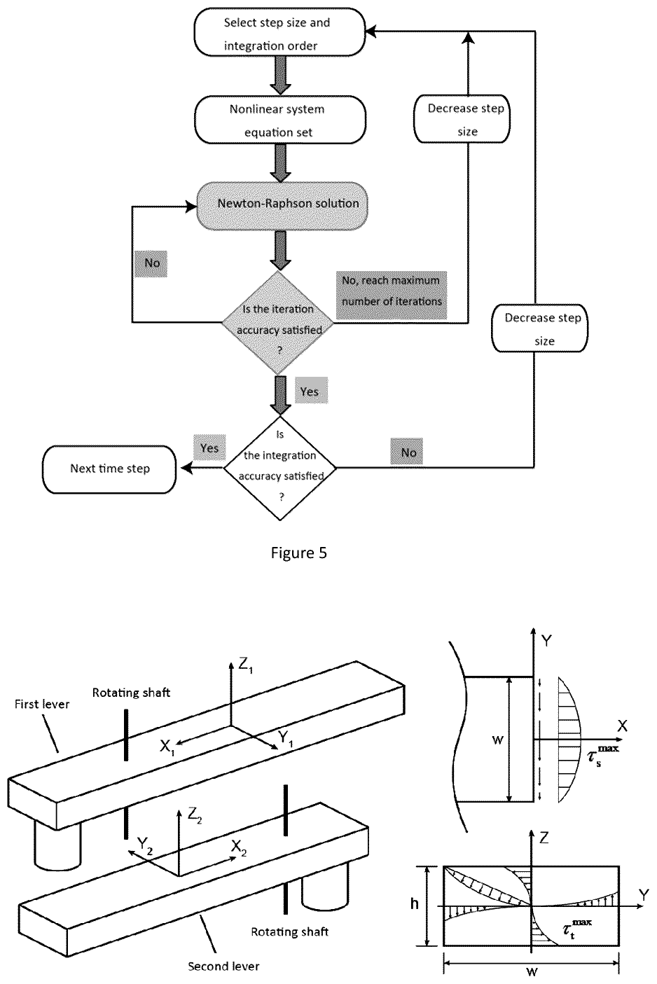

In the above embodiment, it can be seen that the equations are a set of time-varying nonlinear differential-algebraic equations (DAEs), and backward differentiation formula (BDF) shown in FIG. 5 is used to solve the above equations, so as to obtain transient time history response of rigid and flexible multi-body systems during large-scale motion, thereby obtaining information such as rigid body motion trajectories and flexible body deformation states. The dynamic time domain simulation in the embodiments of the present invention can be completed in the above manner.

One embodiment of the present invention provides a jam release device design method for coiled tube drilling rigs, comprising following steps of: modeling the jam release device for coiled tube drilling rigs, wherein a jam release device model for coiled tube drilling rigs can be a digital model of the jam release device for coiled tube drilling rigs as described above; performing dynamics modeling of components in the jam release device model for coiled tube drilling rigs to obtain dynamic equations of the components; accumulating kinetic energies and potential energies in the dynamic equations of the components to obtain a total kinetic energy and a total potential energy of a system; calculating generalized forces corresponding to generalized coordinates caused by active forces on the jam release device model for coiled tube drilling rigs and all contacts of the components; utilizing Lagrange multipliers and gradients of constraints on the generalized coordinates to obtain generalized forces contributed by constraints, thus obtaining a first Lagrange equation set for the jam device model for coiled tube drilling rigs; transforming the first Lagrange equation set into a general form to obtain a time-varying nonlinear differential-algebraic equation set for the jam release device model for coiled tube drilling rigs; and solving the time-varying nonlinear differential-algebraic equation set for the jam release device model for coiled tube drilling rigs to obtain transient time responses during large-scale motion processes, thereby getting motion trajectories and flexible body deformation status information of the components within the jam release device model for coiled tube drilling rigs.

Based on the above design method, it is possible to model and simulate different types of structures or devices, thereby obtaining motion trajectories of various components within the system and deformation states of flexible bodies. This enables one to determine parameters such as the ultimate load of the modeled system, making it easier to analyze various performance parameters of the modeling scheme as well as the temporal variations of these parameters. Furthermore, this facilitates designers in optimizing the design of the scheme.

The design method of the present invention can not only conduct time domain analysis on the operating parameters of the entire system, but also conduct time domain analysis on the load limit, motion range and other parameters of each component that constitutes the system. Therefore, compared with existing design methods, the system design in the present invention is more flexible and has more comprehensive functions.

The design method described in this embodiment can be used to design and analyze various devices. In one embodiment, specific design and data analysis are performed by taking the above-mentioned model of the jam release device for coiled tube drilling rigs as an example.

One embodiment of the present invention provides a digital model of a jam release system for coiled tube drilling rigs, comprising two jam release devices for coiled tube drilling rigs as mentioned above, recorded as a first jam release device model and a second jam release device model; a first mass ball fixedly connected to the first jam release model; a second mass ball fixedly connected to the second jam model, wherein relative positions of the first mass ball and the second mass ball in space are always fixed and unchanged, and are used to simulate quality of injector heads of a drilling rig and drill strings extending into holes; and a rigid plate configured to simulate a hole wall of a drilled hole, wherein contact friction existing between two mass balls and the rigid plate is used to simulate the frictional resistance of the drill string in borehole walls.

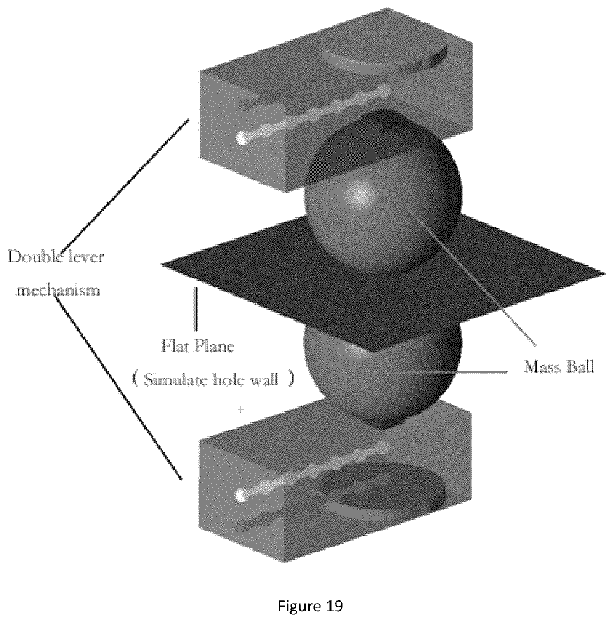

In the present embodiment, in order to reduce the time required for simulation and calculation, and to achieve a performance evaluation and parameter optimization for a single double-lever system, a precise dynamic design description is employed. Based on the aforementioned dynamics modeling method, a simplified dynamic design optimization model of the double-lever mechanism as shown in FIG. 19 is established. This simplified model includes two sets of double-lever jam release mechanisms, two interconnected mass balls used to simulate weight of the injector heads and the drilling string entering boreholes, a plate used to simulate the borehole wall, and contact friction between the mass balls and the plate to simulate the resistance encountered by the drilling column in the orifice wall. Both the mass balls and the simulated orifice wall are modeled as rigid bodies.

In one embodiment, the jam release device design method for the coiled tube drilling rigs further includes performing design optimization on design parameters of the jam release device, and the design optimization comprises: constructing a jam release system model for coiled tube drilling rigs, wherein the jam release system model for coiled tube drilling rigs comprises two jam release device models for coiled tube drilling rigs, respectively recorded as a first jam release device model and a second jam release device model; a first mass ball fixedly connected to the first jam release device model; a second mass ball fixedly connected to the second releasing device model, wherein a relative position of the first mass ball and the second mass ball in space remains unchanged, so as to simulate mass of injector heads of a drilling rig and drill strings inserted into holes; and a rigid plate configured to simulate a hole wall of a borehole, wherein between the first mass ball and the rigid plate exists contact friction, and between the second mass ball and the rigid plate exists contact friction, the contact friction is used to simulate the resistance experienced by drill strings in boreholes; defining parameters of each unit in the jam release system model for coiled tube drilling rigs and performing dynamics modeling on all units in the system to obtain a dynamic model of the jam release system model for coiled tube drilling rigs; conducting dynamic time-domain simulation on the dynamic model of the jam release system model for coiled tube drilling rigs, and optimizing the dynamic time-domain simulation based on particle swarm optimization algorithm to reduce amount of calculation required for simulation; and optimizing the design parameters of the all units in the jam release system model for coiled tube drilling rigs based on simulation results.

In the present embodiment of the present invention, the construction method and simulation method of the coiled tube drilling rig jam system model can be as described above, and will not be described again here. Through design optimization, various parameters in the plan can be accurately selected, and the performance of the system can be analyzed, thereby providing a basis for system improvement.

In the embodiment of the present invention, parameters required for the dynamic design modeling of the double-lever jam release mechanism are as shown in the following table:

### Dynamic Design Parameters of Double Lever Jam Release Mechanism

| Component | Name of Parameter | Paraphrase |
|---|---|---|
| Drive Wheel | Drive_Radius | Radius of Drive Wheel |
| (referred as to | Drive_Height | Height of Drive Wheel |
| Drive_Wheel) | Drive_Column_Height | Column Height of Drive |
| | | Wheel |
| | Drive_GPostion | Drive Wheel Installation |
| | | Position in Global |
| | | Coordinates |
| First Lever | Lever1_Length | Length of First Lever |
| (referred as to | Lever1_Width | Width of First Lever |
| Lever 1) | Lever1_Height | Height of First Lever |
| | Lever1_Notch_Length | Length of Straight Notch of |
| | | First Lever |
| | Lever1_Fulcrum_LPosition | Fulcrum Position of the |
| | | First Lever in Local |
| | | Coordinates |
| | Lever1_Fulcrum_GPosition | Fulcrum Position of the |
| | | First Lever in Global |
| | | Coordinates |
| | Lever1_Elements_Num | Number of Beam Elements |
| | | of First Lever |
| Second Lever | Lever2_Length | Length of Second Lever |
| (referred as to | Lever2_Width | Width of Second Lever |
| Lever 2) | Lever2_Height | Height of Second Lever |
| | Lever2_Fulcrum_LPosition | Fulcrum Position of the |
| | | Second Lever in Local |
| | | Coordinates |
| | Lever2_Fulcrum_GPosition | Fulcrum Position of the |
| | | Second Lever in Global |
| | | Coordinates |
| | Lever2_Elements_Num | Number of Beam Elements |
| | | of Second Lever |
| Output end portion | Output_Length | Length of Output End |
| (referred as to | | Portion |
| Output) | Output_Width | Width of Output End |
| | | Portion |
| | Output_Height | Height of Output End |
| | | Portion |
| | Output_GPostion | Output End Portion |
| | | Installation Global Position |

In addition to the parameters of the double-lever jam release mechanism, the above simplified dynamic design model also needs to define external environment parameters of mass ball, flat plate, and contact friction, as shown in the following table:

### Simplified Model External Environment Parameters for Dynamic Design Optimization

| Component | Name of Parameter | Paraphrase |
|---|---|---|
| Mass Ball | Ball_Radius | Radius of Mass Ball |
| (referred as to Ball) | Ball_Mass | Mass of Mass Ball |
| Flat Plane | Plane_Length | Length of Flat Plane |
| (referred as to Plane) | Plane_Width | Width of Flat Plane |
| | Plane_Height | Height of Flat Plane |
| Contact Friction | K | Contact Stiffness |
| (referred as to Contact) | C | Contact Damping |
| | Velocity_s | Coulomb Friction Static |
| | | Velocity |
| | Velocity_d | Coulomb Friction Dynamic |
| | | Velocity |
| | Miu_s | Coulomb Friction Static |
| | | Coefficient |
| | Miu_d | Coulomb Friction Dynamic |
| | | Coefficient |

The parameter design of double levers needs to be determined based on the strength calculation of the double levers. First, let maximum normal stress σₘₐₓ meet following requirements of maximum normal stress limit σₗᵢₘ of the material:

$${σ}_{lim} = \frac{{σ}_{N}}{n} \geq {σ}_{max} ,$$

where n refers to safety factor, generally taken as 1.1, fatigue limit, as a rule of thumb, is approximately taken as half of strength limit σ_{b}, that is, σ_{N}=0.5σ_{b}.

And maximum normal stress of beam elements is calculated as follows:

$${σ}_{max} = max ( {σ}^{+} , {σ}^{-} ) ,$$

where σ⁺ and σ⁻ are respectively upper and lower bounds of normal stress, which can be calculated by superimposing axial stress and bending stress, and the calculation formula is as follows:

$$\{ \begin{matrix}{σ}_{+} = \frac{{F}_{x}}{A} + \frac{{M}_{y}}{{W}_{y}} + \frac{{M}_{z}}{{W}_{z}} \\ {σ}_{-} = \frac{{F}_{x}}{A} - \frac{{M}_{y}}{{W}_{y}} - \frac{{M}_{z}}{{W}_{z}}\end{matrix} .$$

In the above formula, Fₓ refers to axial force, M_{y} and M_{z} refer to section bending moments in two directions respectively, A is cross-sectional area of lever, and W_{y} and W_{z} are section coefficients of bending resistance in two directions respectively, which can be calculated by following formula:

$$\{ \begin{matrix}{W}_{y} = \frac{{I}_{y}}{h / 2} = \frac{w {h}^{2}}{6} \\ {W}_{z} = \frac{{I}_{z}}{w / 2} = \frac{{w}^{2} h}{6}\end{matrix} .$$

After the parameter design is completed based on the maximum normal stress, the shear stress strength conditions are used for verification. Let its maximum shear stress τₘₐₓ meet following requirements of the maximum shear stress limit τₗᵢₘ of the material:

$${τ}_{lim} = \frac{{τ}_{N}}{n} \geq {τ}_{max} ,$$

where n refers to safety factor, generally taken as 1.1, fatigue limit, as a rule of thumb, is approximately taken as half of the strength limit τ_{b}, i.e. τ_{N}=0.5σ_{b}.

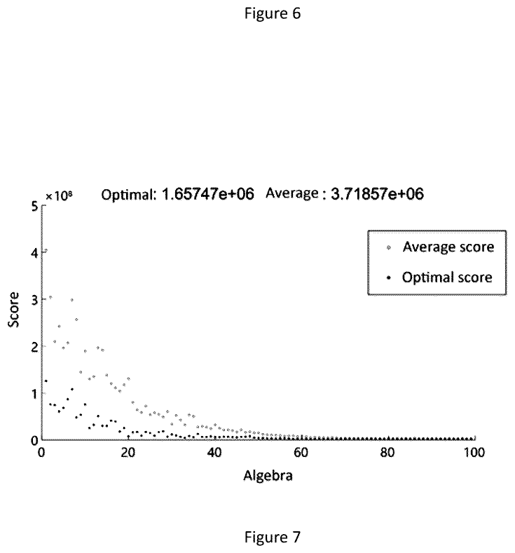

As shown in FIG. 6, for the two levers of present mechanism, the maximum shear stress will be mainly generated by the joint action of Y shear force and X torque on the two levers, that is τₘₐₓ=τₛ^{max}+τₜ^{max}.

When a square-section beam is subjected to shear force, the shear stress in the middle of the cross-section is the largest, which can be calculated by the following formula:

$${τ}_{s}^{max} = \frac{3 {F}_{s}}{2 w h} ,$$

When a square-section beam is torsioned, the shear stress in the middle of the long side of the cross-section is the largest, which can be expressed by the following formula:

$${τ}_{t}^{max} = 2 G θ a - \frac{16 G θ a}{{π}^{2}} {\sum }_{n = 1 , 3 , 5 …}^{∞} \frac{1}{{n}^{2} cosh ( \frac{n π b}{2 a} )} ,$$

where, G is the shear modulus, a is half of the short side, that is, h/2, b is half of the long side, that is, w/2, θ is the torsion angle at the cross section, and the axial torque M can be brought into the following calculation:

$$θ = \frac{M}{\frac{1}{3} {G ( 2 a )}^{3} ( 2 b ) ( 1 - \frac{192}{{π}^{5}} \frac{a}{b} {\sum }_{n = 1 , 3 , 5 …}^{∞} \frac{1}{{n}^{5}} tanh \frac{n π b}{2 a} )} .$$

The present embodiment specifies the lengths of the two levers and the dimensional parameters of other parts of the mechanism as fixed values. The designable parameters include the cross-sectional width and height of the two-stage lever. Based on this mechanism's design, it is not difficult to infer that the normal stress on the second lever and the shear stress on the first lever will be the main causes of potential material failure in the lever. To determine the cross-sectional dimensions at which the second lever reaches maximum normal stress and the first lever reaches maximum shear stress, the design objective function is as follows:

$$min \vert {σ}_{1}^{max} ( {L}_{1} , {W}_{1} , {L}_{2} , {W}_{2} ) - {σ}_{1}^{lim} \vert + \vert {σ}_{2}^{max} ( {L}_{1} , {W}_{1} , {L}_{2} , {W}_{2} ) - {σ}_{2}^{lim} \vert + \vert {τ}_{1}^{max} ( {L}_{1} , {W}_{1} , {L}_{2} , {W}_{2} ) - {τ}_{1}^{lim} \vert$$

$$s . t . {L}_{1}^{lower} \leq {L}_{1} \leq {L}_{1}^{upper}$$

$${W}_{1}^{lower} \leq {W}_{1} \leq {W}_{1}^{u p p e r}$$

$${L}_{2}^{lower} \leq {L}_{2} \leq {L}_{2}^{u p p e r}$$

$${W}_{2}^{lower} \leq {W}_{2} \leq {W}_{2}^{u p p e r} ,$$

where σ₁^{max}, σ₂^{max} and τ₁^{max} are the maximum normal stress of double levers and the maximum shear stress of one lever respectively, which are all functions of the lever cross-section size parameters L₁, W₁, L₂ and W₂ calculated by the dynamic simulation, and σ₁^{lim}, σ₂^{lim} and τare their respective limits. In the optimization process, the section design parameters meet the upper and lower limits Lᵢ^{lower}, Lᵢ^{upper}, Wᵢ^{upper} and Wᵢ^{upper}.

In the above problem, each lever performance evaluation needs to be completed through dynamic time domain simulation. For n parameters to be designed, at least n+1 of dynamic simulations need to be performed to obtain the Jacobian matrix of the objective function, which will cost a huge amount of computational time. Therefore, this application uses a heuristic algorithm—Particle Swarm Optimization (PSO) to complete the above dynamic design. Here is an example demonstrating the optimization effect, with the initial model parameters set as shown in the table below:

### Dynamic Design Parameters of Double-Lever Jam Release Mechanism

| Component | Name of Parameter | Value(default unit is m) | |
|---|---|---|---|
| Drive Wheel | Drive_Radius | 0.2 | |
| (referred as to | Drive_Height | 0.04 | |
| Drive_Wheel) | Drive_Column_Height | Lever1_Height | |
| | Drive_GPostion | (0, 0, 0) | |
| First Lever | Lever1_Length | 0.6 | |
| (referred as to | Lever1_Width | [0.01, 0.1] | |
| Lever 1) | Lever1_Height | [0.01, 0.1] | |
| | Lever1_Notch_Length | 2*Drive_Radius | |
| | Lever1_Fulcrum_LPosition | (0.2, 0, 0) | |
| | Lever1_Fulcrum_GPosition | (−0.5, 0, -Drive_Height/ | |
| | | 2-Lever1_Height/2) | |
| | Lever1_Elements_Num | 6 (pieces) | |
| Second Lever | Lever2_Length | 0.6 | |
| (referred as to | Lever2_Width | [0.01, 0.1] | |
| Lever 2) | Lever2_Height | [0.01, 0.1] | |
| | Lever2_Fulcrum_LPosition | (0.2, 0, 0) | |
| | Lever2_Fulcrum_GPosition | (−0.1, 0, -Drive_Height/2- | |
| | | Lever1_Height- | |
| | | Lever2_Height/2) | |
| | Lever2_Elements_Num | 6 (pieces) | |
| Output end portion | Output_Length | 0.1 | |
| (referred as to | Output_Width | 0.1 | |
| Output) | Output_Height | 0.04 | |
| | Output_GPostion | (0, 0, -Drive_Height/2- | |
| | | Lever1_Height- | |
| | | Lever2_Height- | |
| | | Output_Height/2) | |
| Mass Ball | Ball_Radius | 0.25 | |
| (referred as to Ball) | Ball_Mass | 10000 | |
| Flat Plane | Plane_Length | 1 | |
| (referred as to Plane) | Plane_Width | 1 | |
| | Plane_Height | 10⁻⁸ | |
| Contact Friction | K | 10⁸ | (N/m) |
| (referred as to | C | 1 | (N/m*s) |
| Contact) | Velocity_s | 0 | (m/s) |
| | Velocity_d | 0.01 | (m/s) |
| | Miu_s | 0 | (1) |
| | Miu_d | 0.3 | (1) |

Under the above conditions, the two mass balls will provide 6 tons of friction, which corresponds to the condition where the injector heads on both sides overcome 1 ton of friction. The velocity of the drive wheel is 10 rad/s, and the two levers are made of the same material. The density is 7850.89 kg/m³, the elastic modulus is 206.84 GPa, the Poisson ratio is 0.3, the maximum normal stress limit is σ₁^{lim}=σ₂^{lim}=200 MPa, and the maximum shear stress limit is τ₁^{lim}=0.6×σ₁^{lim}=120 MPa. Take the number of single generation population as 20, and the optimization process is shown in FIG. 7.

The optimization process involved a total of 2000 dynamic simulations, consuming approximately 247 minutes. From the recorded iterative process chart, it can be observed that the optimal solution of each generation after 50 generations has basically become stable, take the optimal solution in the first 100 generations, and the performance assessment results of the 100th generation double-lever jam release mechanism are as follows:

### Performance Evaluation Results of the 100th Generation Double-Lever Jam Release Mechanism

| Type | Name of Parameter | Value | |
|---|---|---|---|
| Design Parameters | Width of First Lever | 0.068737 | m |
| | Height of First Lever | 0.010372 | m |
| | Width of Second Lever | 0.088221 | m |
| | Height of Second Lever | 0.023107 | m |
| Maximum normal | First Lever | 199.9759 | mPa |
| stress | Second Lever | 200.0213 | mPa |
| Maximum shear | First Lever | 121.5553 | mPa |
| stress | Second Lever | 47.3191 | mPa |

| | | |
|---|---|---|
| Maximum Output Amplitude | 0.0081005 | m |

| | |
|---|---|
| Objective Function Score | 1600697.4856 |

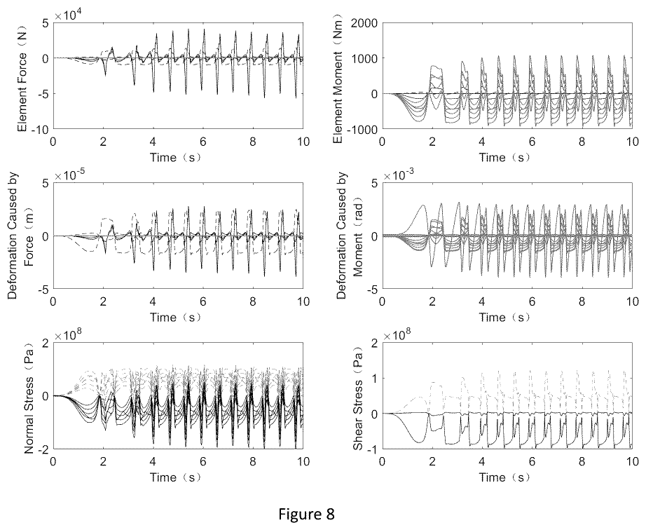

In one embodiment, the load and deformation time domain change curves during the operation of the first lever are obtained, as shown in FIG. 8, where the black solid line is the result in the x-axis direction (length), the black dotted line is the result in the y-direction (width), and the gray thick line is the z-direction (height) result. FIG. 8 also provides the changes in stress of the first lever unit, where the gray dotted line is the upper bound and the black solid line is the lower bound.

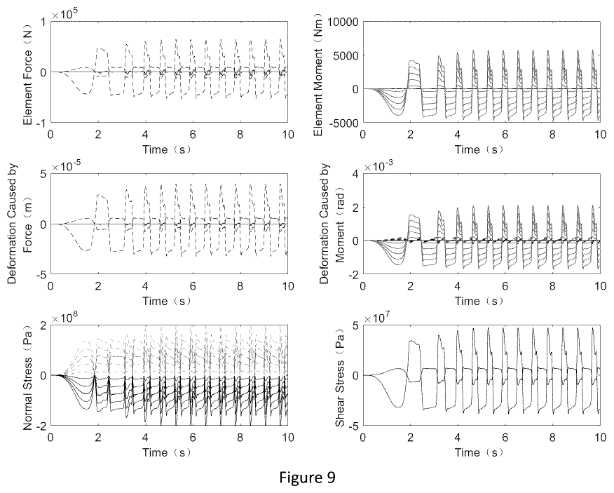

In one embodiment, the load and deformation time domain change curves during the operation of the second lever are obtained as shown in FIG. 9, where the black solid line is the result in the x-axis direction (length), the black dotted line is the result in the y-direction (width), and the gray thick line is the z-direction (height) result. FIG. 9 also includes the changes in stress of the second lever unit, where the gray dotted line is the upper bound and the black solid line is the lower bound.

As shown in the embodiments depicted in FIGS. 8 and 9, it can be observed that the primary lever is mainly subjected to axial force and torque within the plane of lever oscillation. Lateral shear force and axial torque are secondary. Correspondingly, there is significant axial tension and lateral shear deformation, and due to the relatively small design thickness of the lever, bending and torsional deformation occur in three directions during operation. Additionally, due to the large torque of axial torsion, the unit shear stress is relatively high.

The stress situation of the second lever is relatively simple, mainly subjected to lateral shear force and moment in the direction of lever swing. Its deformation is mainly caused by corresponding lateral shear deformation and bending deformation in the plane of lever swing. In addition, due to the small torque of axial torsion, the shear stress of the unit is correspondingly small, mainly caused by lateral shear force.

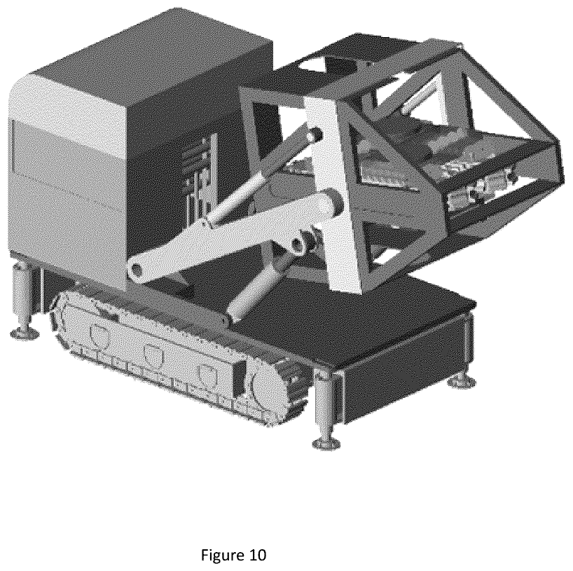

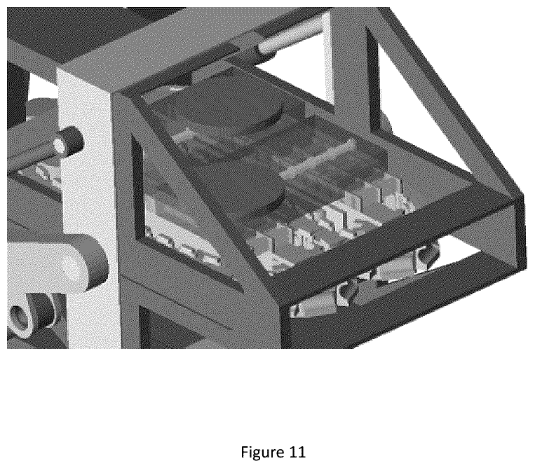

In one embodiment, as shown in FIGS. 10 and 11, several schematics of a digital system of a jam release device for coiled tube drilling rigs are provided. In the present embodiment, a digital system of a jam release device for coiled tube drilling rigs may be equipped with 2 or 4 or more jam release device models for coiled tube drilling rigs.

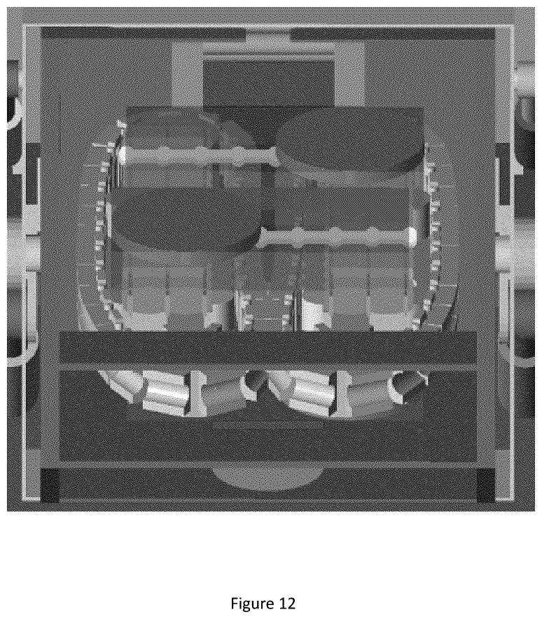

In the embodiment of the present invention, the aforementioned double lever jam release mechanism is alternately installed on a chain roller system of a drilling rig as shown in FIG. 12 for full-model jam release process domain simulation. The full model of a coiled tube drilling rig is as shown in FIG. 12, this embodiment takes FIG. 12 as an example, where the grey transparent rectangular part in the figure represents a set of double lever jam release mechanisms, four sets in total, symmetrically arranged in pairs up and down.

In one embodiment, an outer diameter of a middle coiled tube is 2-⅞ inches, and a hole diameter is 4 inches. The measuring point parameters for the trajectory are shown in the table below:

TABLE 1
Measuring point parameters of borehole trajectory

| Depth (m) | Inclination (deg) | Azimuth (deg) |
|---|---|---|
| 0 | 10 | 0 |
| 100 | 10 | 0 |
| 200 | 0 | 0 |

Drill bits are firmly connected to hole bottom portions to simulate the working condition of the drill bit stuck. First, set the displacement of the middle extrusion plate of the drilling rig to 23 mm, so that the chain clamping block is in a clamping condition for the middle coiled pipe. After 5 seconds, use the STEP function shown in the following formula to gradually increase the drive wheel speed of the double-lever mechanism to 10 rad/s after 5 seconds, and the chain rollers on both sides drive the continuous tube to vibrate axially.

$$step ( time , {t}_{0} , {x}_{0} , {t}_{1} , {x}_{1} ) = \{ \begin{matrix}{x}_{0} & , time \leq {t}_{0} \\ {x}_{0} + ( \frac{time - {t}_{0}}{{t}_{1} - {t}_{0}} ) \cdot ( {x}_{1} - {x}_{0} ) & , {t}_{0} < time \leq {t}_{1} \\ {x}_{1} & , time \geq {t}_{1}\end{matrix} .$$

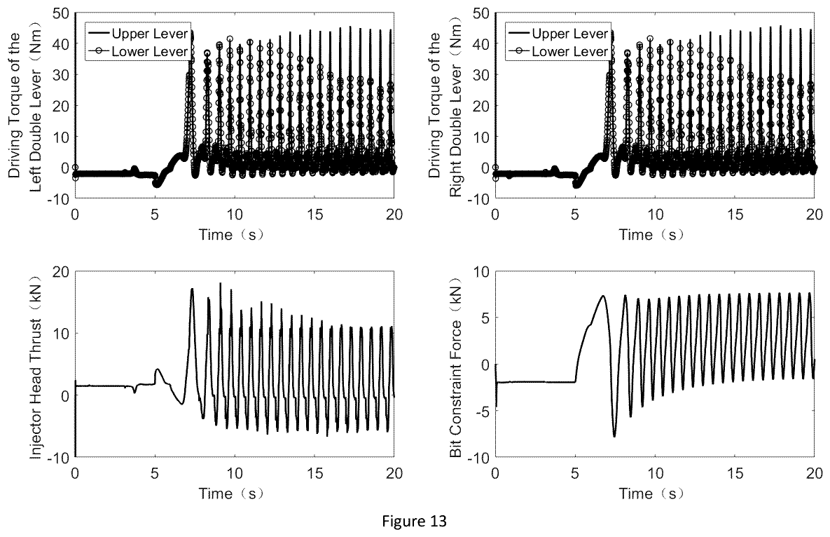

During the above process, the driving torque of the four double-lever drive wheels, the thrust provided by injector heads, and constraint forces on the drill bit are shown in FIG. 13. As can be seen from FIG. 13, the double-lever system provides a periodic injector head thrust in the range of −6 kN to 10 kN with a relatively small input torque of less than 50 Nm. Through the consumption of friction between the drill strings and borehole walls, a periodic high-frequency axial jam release force in the range of about −1.5 kN to 7.5 kN is provided to the stuck part of the drill bits.

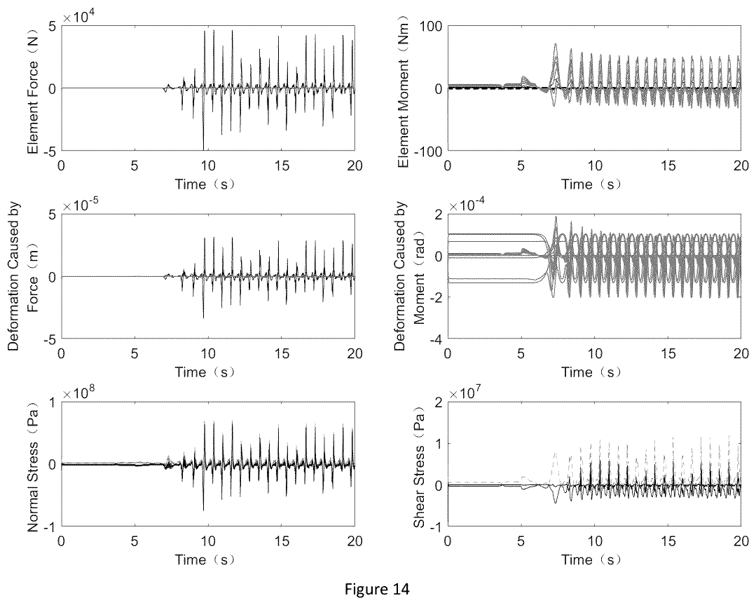

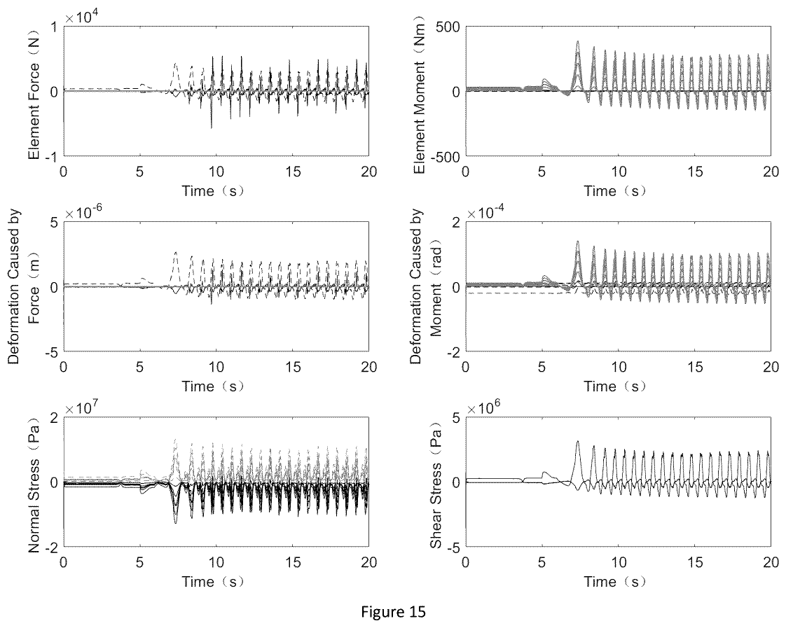

It is not difficult to infer from the driving torque that the stress states of the four groups of double-lever mechanisms are basically the same. The load and deformation time domain change curves of one group of second levers during operation are shown in FIGS. 14 and 15. The black solid line is the result in the x-axis direction (length), the black dotted line is the result in the y-direction (width), and the gray thick line is the result in the z-direction (height). The figure also includes the changes in stress of the lever unit, where the gray dotted line is the upper bound and the black solid line is the lower bound. It can be seen from the figure that the maximum normal stress of the first lever is about 75.9 MPa and the maximum shear stress is about 13.9 MPa. The maximum normal stress and the maximum shear stress of the second-level lever are about 14.4 MPa and about 3.5 MPa. All meet the design strength requirements.

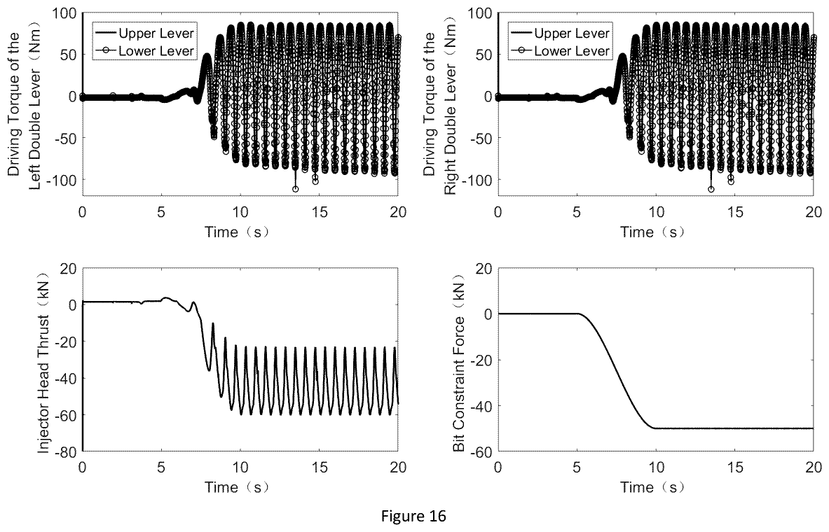

The constraints on the drill bit in the operating conditions have been changed to an axial tensile force of 50 kN. The simulation of the unsticking process mentioned earlier was repeated. The driving torque of the four dual lever drive wheels, the thrust provided by the injector heads, and the constraint forces at the drill bit are shown in FIG. 16.

From FIG. 16, it can be observed that during the 5-10 second period, the constraint force at the drill bit gradually increases to 50 kN. The double lever system provides a periodic injector head lifting force in the range of 23 kN to 60 kN with a relatively small input torque of approximately 100 Nm, and the driving torque of the four sets of double lever mechanisms is basically consistent.

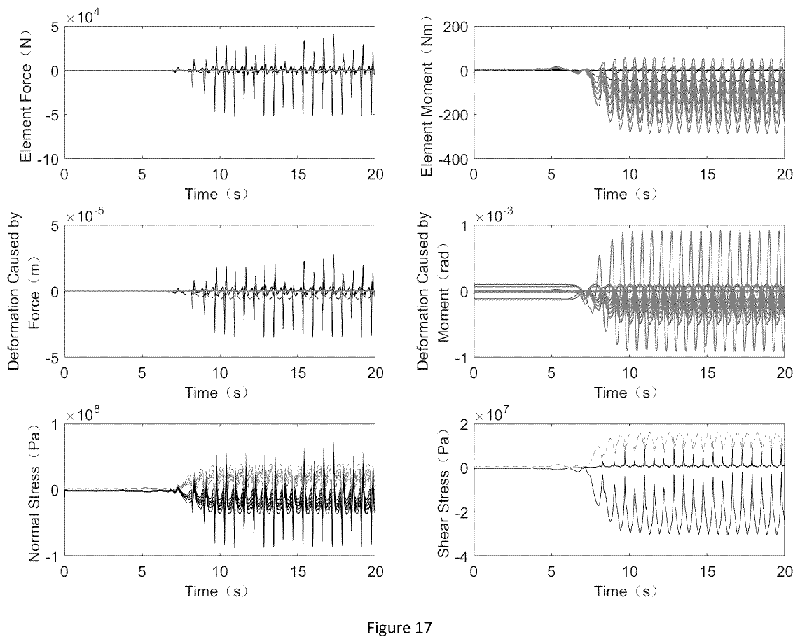

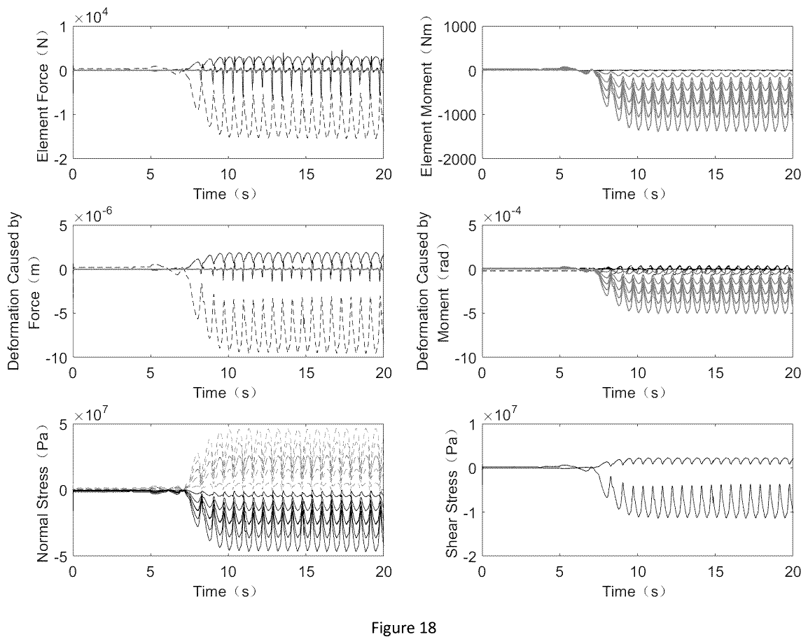

The load and deformation time domain change curves of one set of second levers during operation are obtained, as shown in FIGS. 17 and 18. The black solid line is the result in the x-axis direction (length), the black dotted line is the result in the y-direction (width), and the gray thick line is the z-direction (height) result. The figure below also includes the changes in stress of the lever unit, where the gray dotted line is the upper bound and the black solid line is the lower bound. It can be seen from the figure that the maximum normal stress of the first lever is about 87.6 MPa and the maximum shear stress is about 30.6 MPa. The maximum normal stress and the maximum shear stress of the second-level lever are about 47.0 MPa and about 11.5 MPa. All meet the design strength requirements.

In the embodiments of the present invention, a digital model of a double-lever jam release mechanism for injector heads of coiled tube drilling rigs is provided, and in the digital model, the mechanism can convert a smaller driving torque into a larger axial thrust through the double levers and provide periodic jam release forces to the injector head chain rolling system, which enriches jam release methods of coiled tubing drilling machines, and the periodic jam release forces can also be used to reduce drill string friction during regular drilling processes and increase bottom hole drilling pressure.

Furthermore, in the embodiments, a multi-body dynamics design concept is proposed for this mechanism, which evaluates the performance indicators of the mechanism based on a dynamic model accurately described by parameterization, and combines it with an optimization algorithm to realize the dynamics of the coiled tubing drilling rig injector head system, thereby ensuring that the performance of the mechanism meets the overall design requirements and has excellent dynamic capability.

In one embodiment, according to the design results, the jam release device for coiled tubing drilling rigs can provide the injector head with a maximum de-stuck force of about 12 tons. The results of the full model simulation of a drilling rig show that the double-lever mechanism designed in this embodiment can meet the jam release requirements.

It can be understood that on the basis of the embodiments of the present application, the lever principle can be applied to realize the conversion of rotational motion to reciprocating linear motion and the function of thrust amplification through a single lever or multiple levers such as three levers or four levers. Other lever design parameters and other “multi-lever” mechanisms with different combinations with the present invention can be installed on the drilling rig to achieve jam release function under different load conditions.

Other optimization methods besides the particle swarm optimization algorithm mentioned in the embodiments of this application may be used to realize the dynamic design of the device.

In one embodiment, a computer device is proposed, which includes a memorizer, a processor, and a computer program stored in the memorizer and executable on the processor. When the processor executes the computer program, it reproduces the model and conducts simulation and parameter optimization, according to the method provided in this embodiment.

In another embodiment, a computer-readable storage medium is provided with a computer program stored on it. When the computer program is executed by the processor, the processor reproduces the model and conducts simulation and parameter optimization, according to the method provided in this embodiment.

It should be understood that although the steps in the models, diagrams, or processes of each embodiment are shown sequentially by arrows in this application, these steps are not necessarily executed in the order indicated by the arrows. Unless otherwise specified, the execution of these steps is not strictly limited by sequence. The steps can be executed in a different order. Moreover, at least some steps in each embodiment may include multiple sub-steps or stages. These sub-steps or stages are not necessarily completed at the same time but can be executed at different times, and their execution sequence is not necessarily consecutive but may alternate with at least some sub-steps or stages of other steps or embodiments.

Those skilled in the art will understand that implementing all or part of the process in the above embodiments can be accomplished by instructing relevant hardware through a computer program, which may be stored in a non-volatile computer-readable storage medium. When executed, the program may include the process of the embodiments as described above. References to memory, storage, database, or other media in the various embodiments provided in this application may include non-volatile and/or volatile storage. Non-volatile storage may include read-only memory (ROM), programmable ROM (PROM), erasable programmable ROM (EPROM), electrically erasable programmable ROM (EEPROM), or flash memory. Volatile storage may include random access memory (RAM) or external cache memory. For illustration purposes and not limitation, RAM can take various forms such as static RAM (SRAM), dynamic RAM (DRAM), synchronous DRAM (SDRAM), double data rate SDRAM (DDR SDRAM), enhanced SDRAM (ESDRAM), synchronous link (Synchlink) DRAM (SLDRAM), Rambus direct RAM (RDRAM), Direct Rambus DRAM (DRDRAM), and Rambus DRAM, etc.

The technical features of the aforementioned embodiments can be combined in any way. For the sake of brevity, not all possible combinations of the technical features in the aforementioned embodiments have been described. However, as long as there are no contradictions in the combination of these technical features, they should be considered within the scope of the present specification.

The aforementioned embodiments represent only several implementation methods of the present application, and their descriptions are relatively specific and detailed. However, this should not be interpreted as limiting the scope of the patent application. It should be pointed out that for those skilled in the art, without departing from the conception of the present application, various modifications and improvements can still be made, and these are all within the scope of protection of the present application's patent. Therefore, the scope of protection of the present patent application should be based on the attached claims.

1. A jam release device for coiled tube drilling rigs, comprising:
a drive shaft, wherein an end portion of the drive shaft is fixed on a motor rotating shaft of a drive motor, the drive motor is fixedly connected to a base frame, so as to drive the drive shaft to rotate centered on a connection point thereof with the drive motor;
a first lever, wherein the first lever is rotationally connected to the base frame via a first fulcrum, on the first lever is further provided a first groove, on the drive shaft is fixedly provided an input end portion, the input end portion is slidably connected to the first groove, so as to drive the first lever to rotate around the first fulcrum; and
a second lever, wherein the second lever is rotationally connected to the base frame via a second fulcrum, on the second lever are further provided a second groove and an output groove, on the first lever is further fixedly provided a transmission end, and the transmission end is slidably connected to the second groove, so as to drive the second lever to rotate around the second fulcrum; and
on the output groove is slidably arranged an output end portion, and the output end portion is used to connect with a base of a chain roller system of a drilling rig, so that the chain roller system applies high-frequency axial vibration excitation to coiled tubes clamped.

2. The jam release device for coiled tube drilling rigs according to claim 1, wherein the drive shaft is disc-shaped, a motor rotating shaft of the drive motor is connected at a center of the disc-shaped drive shaft, and the input end portion is arranged at a disc edge portion of the disc-shaped drive shaft.

3. The jam release device for coiled tube drilling rigs according to claim 1, wherein a distance between the input end portion and the first fulcrum is greater than a distance between the transmission end and the first fulcrum, and a distance between the transmission end and the second fulcrum is greater than a distance between the output end portion and the second fulcrum.

4. A jam release system for coiled tube drilling rigs comprising at least two jam release devices for coiled tube drilling rigs according to claim 1, wherein
when the jam release system for coiled tube drilling rigs comprises two jam release devices for coiled tube drilling rigs, marked as a first jam release device for coiled tube drilling rigs and a second jam release device for coiled tube drilling rigs; and
an output end portion of the first jam release device for coiled tube drilling rigs and an output end portion of the second jam release device for coiled tube drilling rigs are arranged on symmetrical two sides of bases of chain roller systems of a coiled tube drilling rig.

5. A jam release device model for coiled tube drilling rigs, comprising:
a drive shaft assembly, wherein an end portion of the drive shaft assembly is fixed to a motor rotating shaft of a drive motor assembly, the drive motor assembly is fixedly connected to a base frame assembly so as to drive the drive shaft assembly to rotate around a connection point thereof with the drive motor assembly;
a first lever assembly, wherein the first lever assembly is rationally connected to the base frame assembly via a first fulcrum, the first lever assembly is further provided with a first groove, on the drive shaft assembly is further fixedly provided an input end portion, and the input end portion is slidably connected to the first groove on the first lever assembly so as to drive the first lever assembly to rotate around the first fulcrum;
a second lever assembly, wherein the second lever assembly is rotationally connected to the base frame assembly via a second fulcrum, the second lever assembly is further provided with a second groove and an output groove, on the first lever assembly is fixedly provided a transmission end, and the transmission end is slidably connected to the second groove on the second lever assembly, so as to drive the second lever assembly to rotate around the second fulcrum; and
on the output groove is slidably arranged an output end portion, and the output end portion is used to connect with a chain roller base system model of a drilling rig, so that the chain roller system model applies high-frequency axial vibration excitation to a coiled tube clamped.

6. A jam release device design method for coiled tube drilling rigs, comprising following steps of:
modeling the jam release device for coiled tube drilling rigs according to claim 5 to obtain a jam release device model for coiled tube drilling rigs;
performing dynamics modeling of components in the jam release device model for coiled tube drilling rigs to obtain dynamic equations of the components;
accumulating kinetic energies and potential energies in the dynamic equations of the components to obtain a total kinetic energy and a total potential energy of a system;
calculating generalized forces [symbol] corresponding to generalized coordinates caused by active forces on the jam release device model for coiled tube drilling rigs and all contacts of the components; utilizing Lagrange multipliers λ_{α} and gradients of constraints on the generalized coordinates
$$\frac{\partial {C}_{α}}{\partial {q}_{j}}$$
to obtain generalized forces contributed by constraints, thus obtaining a first Lagrange equation set for the jam device model for coiled tube drilling rigs;
transforming the first Lagrange equation set into a general form to obtain a time-varying nonlinear differential-algebraic equation set for the jam release device model for coiled tube drilling rigs; and
solving the time-varying nonlinear differential-algebraic equation set for the jam release device model for coiled tube drilling rigs to obtain transient time responses during large-scale motion processes, thereby getting motion trajectories and flexible body deformation status information of the components within the jam release device model for coiled tube drilling rigs.

7. The jam release device design method for coiled tube drilling rigs according to claim 6, wherein rigid body modeling is performed on the drive shaft assembly in the jam release device model for coiled tube drilling rigs and a method for obtaining dynamic equations of the drive shaft assembly is as follows:
letting a generalized coordinate be: q_{R}=[r_{R}^{T} φ_{R}^{T}]^{T}, where r_{R} represents a position of a center of mass of a rigid body, and φ_{R} represents an attitude of the rigid body,
expressing generalized velocity and acceleration velocity thereof as:
$${\dot{q}}_{R} = {[ \begin{matrix}{\dot{r}}_{R}^{T} & {\dot{φ}}_{R}^{T}\end{matrix} ]}^{T} and {{\ddot{q}}_{R} [ \begin{matrix}{\ddot{r}}_{R}^{T} & {\ddot{φ}}_{R}^{T}\end{matrix} ]}^{T} ,$$
expressing angular velocity and angular acceleration velocity of the rigid body in a local coordinate system as:
$${\overline{ω}}_{R} = {H}^{T} {\dot{φ}}_{R} and {\dot{\overline{ω}}}_{R} = {H}^{T} {\ddot{φ}}_{R} + {\dot{H}}^{T} {\dot{φ}}_{R} ,$$
where H represents transformation matrix, and for any rotation vector φ=[φ₁ φ₂ φ₃]^{T}, an equation is obtained as follows:
$$H ( φ ) = I + \frac{1 - cos φ}{{φ}^{2}} \tilde{φ} + \frac{φ - sin φ}{{φ}^{3}} \tilde{φ} \tilde{φ} ,$$
where φ=∥φ∥, \tilde{φ} and is a corresponding anti-symmetric matrix of φ;
letting a generalized inertial force of the rigid body be:
$${Q}_{iner}^{R} = [ \begin{matrix}{Q}_{t}^{R} \\ {Q}_{r}^{R}\end{matrix} ] = - [ \begin{matrix}m {\ddot{r}}_{R} \\ H [ {J}_{R} {\dot{\overline{ω}}}_{R} + {\overline{ω}}_{R} \times ( {J}_{R} {\overline{ω}}_{R} ) ]\end{matrix} ] ,$$
where J_{R}=diag(J_{Rx} J_{Ry} J_{Rz}) represents a principal moment of inertia tensor of the rigid body in the local coordinate system; and
combining above equations, and obtaining a rigid body dynamics equation as follows:
$${Q}_{iner}^{R} + {Q}_{ext}^{R} + {Q}_{cons}^{R} = 0 ,$$
where Qₑₓₜ^{R} and Q_{cons}^{R} refer to a generalized external force and a generalized constraint force on the rigid body.

8. The jam release device design method for coiled tube drilling rigs according to claim 6, wherein the first lever assembly and the second lever assembly in the jam release device model for coiled tube drilling rigs are modeled by using beam elements; and
a method of using beam elements for modeling and obtaining respective dynamic equations thereof is as follows:
letting generalized coordinates thereof be:
$${q}_{B} = {[ \begin{matrix}{q}_{I}^{T} & {q}_{J}^{T}\end{matrix} ]}^{T} = {[ \begin{matrix}{r}_{I}^{T} & {φ}_{I}^{T} & {r}_{J}^{T} & {φ}_{J}^{T}\end{matrix} ]}^{T} ,$$
and generalized inertial forces of the beam elements be:
$${Q}_{iner}^{B} = - ρ AL [ {\int }_{0}^{1} {N}_{r}^{T} {N}_{r} d ξ ] {\ddot{q}}_{B} - ρ L {\int }_{0}^{1} \{ {N}_{φ}^{T} H [ J {\dot{\overline{ω}}}_{B} + {\overline{ω}}_{B} \times ( J {\overline{ω}}_{B} ) ] \} d ξ ,$$
where ρ, A and L represent density, cross-sectional area and length of the beam elements respectively, and Nᵣ and N_{φ} represent form functions of translational and rotational coordinates respectively;
letting generalized elastic forces of the beam elements be::
$${Q}_{elas}^{B} = - L {\int }_{0}^{1} [ {( \frac{\partial \overline{γ}}{\partial {q}_{B}} )}^{T} \overline{Γ} + {( \frac{\partial \overline{κ}}{\partial {q}_{B}} )}^{T} \overline{M} ] d ξ ,$$
where γ̅ and Γ̅ respectively represent strain vectors of the beam elements and corresponding internal forces thereof, κ̅ and M̅ respectively represent bending vectors of the beam elements and corresponding internal forces thereof; and
combining above equations, and obtaining dynamic equation of the beam elements based on above equations as follows:
$${Q}_{iner}^{B} + {Q}_{elas}^{B} + {Q}_{ext}^{B} + {Q}_{cons}^{B} = 0 ,$$
where Qₑₓₜ^{B} and Q_{cons}^{B} represent a generalized external force and a generalized constraint force on beam elements.

9. The jam release device design method for coiled tube drilling rigs according to claim 6, wherein a time-varying nonlinear differential-algebraic equation set of the jam release device model for coiled tube drilling rigs are obtained in following way:
listing all the components of the jam release device model for coiled tube drilling rigs and obtaining following equations about a generalized coordinate vector q as well as all constraints C_{α} on generalized coordinates of the system:
$$q = {[ {q}_{1} , {q}_{2} , … {q}_{k} ]}^{T} , \\ {C}_{α} ( q , t ) = 0 , and \\ α = 1 , … , m$$
accumulating kinetic energies and potential energies of all components in the jam release device model to obtain the total kinetic energy T and total potential energy U of the system, and then obtain the active forces on the model and the generalized forces [symbol] corresponding to all generalized coordinates caused by all contacts, and then utilizing the Lagrange multipliers λ_{α} and the gradients of the constraints on the generalized coordinates
$$\frac{\partial {C}_{α}}{\partial {q}_{j}}$$
to obtain generalized forces contributed by the constraints, and then getting a first kind of Lagrangian equation of the system as follows:
$$\{ \begin{matrix}\frac{d}{dt} \frac{\partial T}{\partial {\dot{q}}_{j}} - \frac{\partial T}{\partial {q}_{j}} + \frac{\partial U}{\partial {q}_{j}} + {\sum }_{α = 1}^{m} {λ}_{α} \frac{\partial {C}_{α}}{\partial {q}_{j}} - {Q}_{j}^{e} = 0 , & j = 1 , … , k \\ {C}_{α} ( q , t ) = 0 , & α = 1 , … , m\end{matrix} ,$$
converting the above equation to matrix form and obtaining:
$$\{ \begin{matrix}M \ddot{q} + {C}_{q}^{T} λ - Q ( \dot{q} , q , t ) = 0 \\ C ( q , t ) = 0\end{matrix} ,$$
introducing notations y=(q^{T}, λ^{T})^{T} and λ=(λ₁, . . . , λₘ) to obtain a general form of the above equation, and then getting the time-varying nonlinear differential algebraic equation set of the jam release device model for coiled tube drilling rigs:
$$F ( y , \dot{y} , \ddot{y} , t ) = 0 ,$$
where \dot{y} and ÿ represent first and second derivatives of y with respect to time t.

10. The jam release device design method for the coiled tube drilling rigs according to claim 6 further comprising performing design optimization on design parameters of the jam release device for coiled tube drilling rigs, wherein the design optimization comprises:
constructing a jam release system model for coiled tube drilling rigs, wherein the jam release system model for coiled tube drilling rigs comprises:
two jam release device models for coiled tube drilling rigs, respectively recorded as a first jam release device model and a second jam release device model;
a first mass ball fixedly connected to the first jam release device model;
a second mass ball fixedly connected to the second releasing device model, wherein a relative position of the first mass ball and the second mass ball in space remains unchanged, so as to simulate mass of injector heads of a drilling rig and drill strings inserted into boreholes; and
a rigid plate configured to simulate a hole wall of a borehole, wherein between the first mass ball and the rigid plate exists contact friction, between the second mass ball and the rigid plate exists contact friction as well, and the contact friction is used to simulate frictional resistance experienced by drill strings in boreholes;
defining parameters of each unit in the jam release system model for coiled tube drilling rigs and performing dynamics modeling on all units in the system to obtain a dynamic model of the jam release system model for coiled tube drilling rigs;
conducting dynamic time-domain simulation on the dynamic model of the jam release system model for coiled tube drilling rigs, and optimizing the dynamic time-domain simulation based on particle swarm optimization algorithm to reduce amount of calculation required for simulation; and
optimizing the design parameters of the all units in the jam release system model for coiled tube drilling rigs based on simulation results.
